(19) United States
(12) Patent Application Publication
(10) Pub. No.: US 2005/0241778 A1
(43) Pub. Date: Nov. 3, 2005

(54) Ultimate auto sunshade

(76) Inventor: Tyler A. Darland, Hayward, CA (US)

Correspondence Address: Tyler A Darland;Ste 190, 25125 Santa Clara Street, Hayward, CA, 94544, US

(21) Appl. No.: 10/838,439

(22) Filed: May 3, 2004

(51) Int. Cl. A47H 1/00; B60J 7/00

(52) U.S. Cl. 160/105

(57) ABSTRACT

Ultimate Auto Sunshade with an a rectangular or custom fit shape screen portion to various size and shaped automobile windows, loop fastening strips sewn to the top, front and rear side of the screen portion, adhesive hook fastening strips that adhere to the interior of the automobile's rear side door. A preferred embodiment includes the loop fastening strips attaching to the hooks at the top, front and rear side of an automobile door around the inside of the door window, thereby enclosing the window and tightly sealing the invention on three sides when the door is closed, thereby creating shade for the occupant of the automobile even when the window is in an open state.

### CROSS REFERENCE TO RELATED APPLICATION

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field sunshades more specifically to a automobile sunshade.

Automobiles are well known. They consist of a plurality of wheels, seats, a frame, drive train, doors and windows to allow visibility. However, while the windows allow for the occupants to have visibility the occupants are exposed and unprotected from the sunlight during daytime hours, thereby causing discomfort to the occupants. Therefore there is a need for an additional sunshade from the sun during daytime hours.

### BRIEF SUMMARY OF THE INVENTION

The primary object of the invention is to provide a sunshade for an automobile that is easy to attach and is secured to the door of an automobile on top and both sides.

Another object of the invention is to provide a sunshade that maintains its shape and provide protection while the rear side window is lowered or open.

A further object of the invention is to provide a sunshade that is easy and inexpensive to manufacture.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Ultimate Auto Sunshade comprising: a screen portion to fit various automobile window dimensions, loop fastening strips sewn along the top and sides of the screen, and hook adhesive fastening strips that adhere to the automobile door placed around the window between the window frame and edge of door.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a perspective view of the invention with the sunshade in place in its open-door state.

FIG. 2 is a perspective view of the invention in place in its closed-door state with the window down.

FIG. 3 is a plan view of invention in its open state.

FIG. 4 is a perspective view of adhesive hooks around automobile door with invention removed in its open-door state.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claim and as a representative basis for teaching one skilled in the art to employ the present invention in virtually any appropriately detailed system, structure or manner.

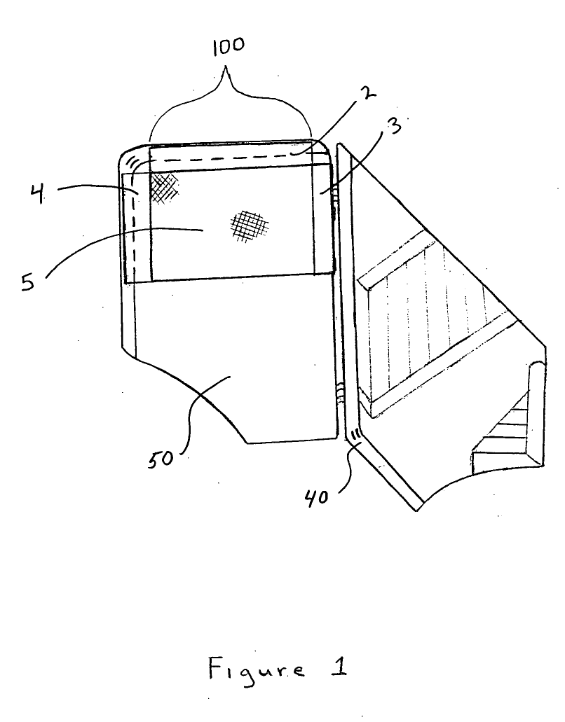

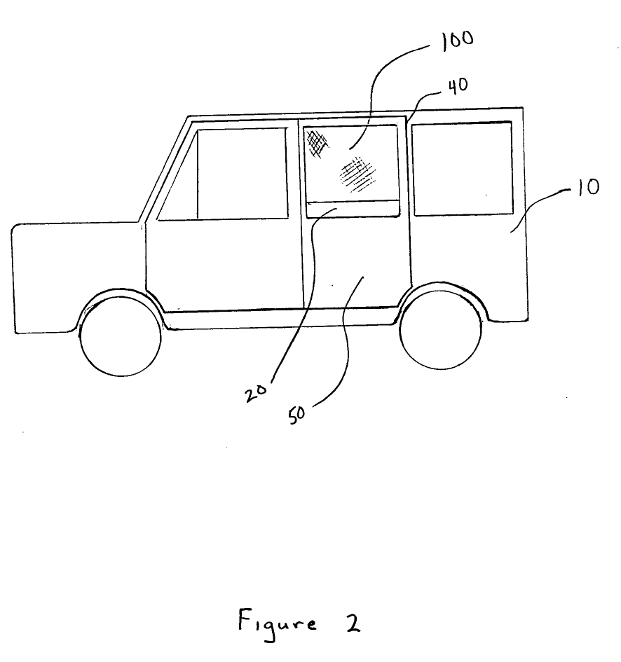

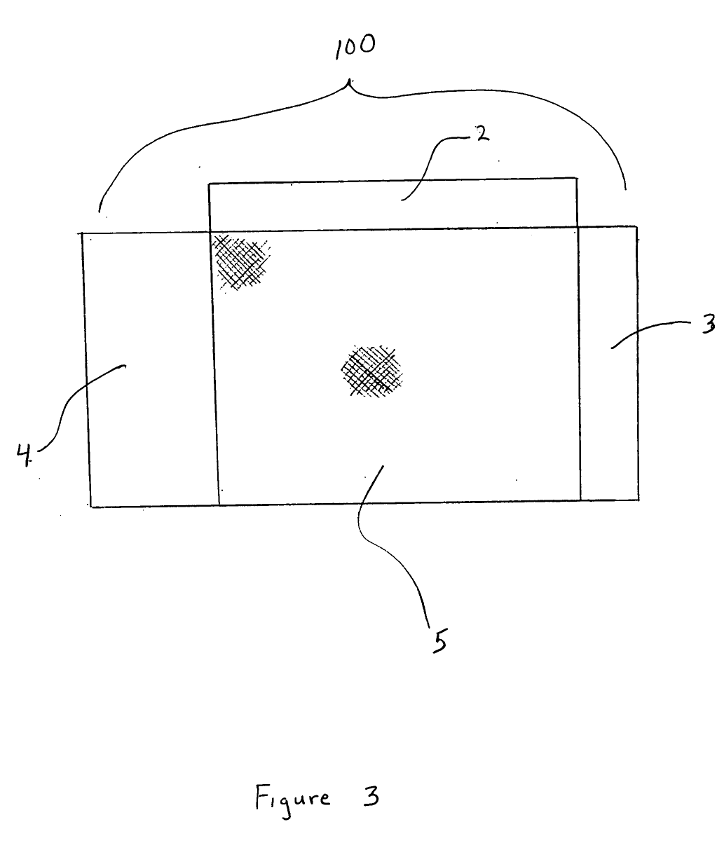

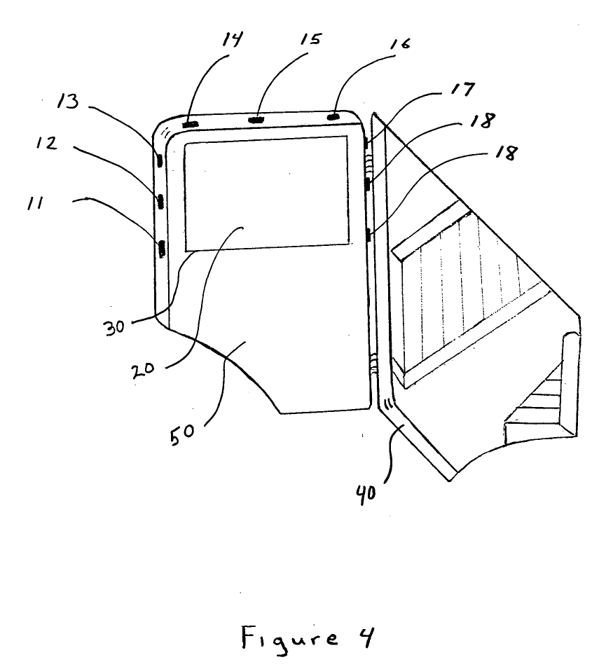

Referring to FIG. 1 we see a perspective view of the invention 100 shown attached to a standard automobile rear side door 50. The invention 100 is comprised of a flexible screen portion 5, three loop fastening strips 2,3,4 are sewn along the top, front and rear side of the screen as shown in FIG. 3, and nine adhesive hook fastening strips 11,12,13,14,15,16,17,18,19 that adhere to the automobile rear side door 50 spaced around the window frame 30 along the top, front and rear side as shown in FIG. 4. The screen 5 is rectangular in shape and is approximately ______ inches long and ______ inches wide. The screen 5 is made of flexible polyester plastic or other standard flexible screening material. The three loop fastening strips 2,3,4 approximately ______ inches long ______ inches wide. Each loop fastening strip is sewn along the top, front and rear side of the screen 5. The nine adhesive hook fastening strips 11,12,13,14,15,16,17,18,19 approximately ______ inches long and ______ inch wide that are spaced to adhere along the top, front and rear side of the automobile rear side door 50 centered between the window frame 30 and edge of door 50. When the door 50 is closed the hook 11,12,13,14,15,16,17,18,19 and loop fastening strips 2,3,4 are further bound together by the automobile frame 40 and door 50 to provide protection from the sun while the automobile 10 is moving and allow window 20 full up and down motion as shown in FIG. 2. The three loop fastening strips 2,3,4 are used to removably attach the sunshade 100 to the adhesive hook fastening strips 11,12,13,14,15,16,17,18,19 that remain in place on the automobile rear side door 50 as shown in FIG. 1. The shape of the screen 5 is such that each edge of the screen 5 makes intimate contact with the window frame 30 so that the screen 5 can fully protect the occupants of the automobile 10 from the uncomfortable and potentially damaging effects of full exposure to the sun. The loop fastening strips 2,3,4 allows for flex to fit on most automobile rear side doors and can be cut to size and shape to fit any automobile rear side door 50. The invention 100 protects the occupant's face and body from full exposure to the sun but allows the occupant to obtain visibility though the invention. While the invention has been described in connection with a preferred embodiment, it is not intended to limit the scope of the invention to the particular from set forth, but on the contrary, it is intended to cover such alternatives, modifications, and equivalents as may be included within the spirit and scope of the invention as defined by the claims.

1. Ultimate Auto Sunshade comprising:
a rectangular or custom fit shape screen portion to various size and shaped automobile windows;
loop fastening strips; and
said loop fastening sewn to said screen;
adhesive hook fastening strips; and
said adhesive hook fastening strips that adhere to the automobile door.

2. Ultimate Auto Sunshade as claimed in claim 1 where as the adhesive hook fastening strips adhere to the interior of automobile rear side door between the edge door and window frame. The said sunshade is then attached to the hooks by way of loop strips and is further secured inside by the closed door on top, front and rear sides, thereby creating shade for the occupant of the automobile even when the automobile window is fully open.

3. Ultimate Auto Sunshade as claimed in claim 1 wherein said screening material is comprised of fine mesh polyester material.

4. Ultimate Auto Sunshade as claimed in claim 1 wherein said screen is approximately ______ inches long ______ inches wide to cover various automobile windows.

5. Ultimate Auto Sunshade as claimed in claim 1 wherein said loop fastening strips is approximately ______ inches long ______ inches wide.

6. Ultimate Auto Sunshade as claimed in claim 1 wherein said hook fastening strips is approximately ______ inch long ______ inch wide.
